(19) United States
(12) Patent Application Publication
(10) Pub. No.: US 2020/0364630 A1
(43) Pub. Date: Nov. 19, 2020

(54) SYSTEM AND METHOD FOR MANAGING TRANSPORTATION VESSELS

(71) Applicant: Target Brands, Inc., Minneapolis, MN (US)

(72) Inventors: Akshay Bhave, Bengaluru (IN); Vishal Gupta, Mumbai (IN); Brooke Luedke, Minneapolis, MN (US); Jacqlyn Poss, Minneapolis, MN (US); Ishita Roy, Bengaluru (IN); Saptarshi Saha, Bengaluru (IN); Samantha Stanke, Minneapolis, MN (US); Matthew Titus, Minneapolis, MN (US)

(21) Appl. No.: 16/746,590

(22) Filed: Jan. 17, 2020

Related U.S. Application Data
(63) Continuation-in-part of application No. 16/413,464, filed on May 15, 2019.

(51) Int. Cl. G06Q 10/04; G06Q 10/06; G06Q 50/28; G06Q 10/08

(52) U.S. Cl. CPC G06Q 10/047; G06Q 10/087; G06Q 50/28; G06Q 10/06315

(57) ABSTRACT

Methods and systems for managing transportation vessels in an enterprise system are disclosed. One method includes receiving inputs related to historical transportation vessel usage, the inputs including a transportation time and shipment demand. The method includes automatically determining a best fit distribution for each of the usage characters, and performing, for each of the plurality of pairs of locations, a plurality of simulations using a randomly-selected value for each of the usage characteristics. Each of the plurality of simulations includes an optimized output of a number of transportation vessels required to meet a demand for each pair of locations, such that the outputs of the plurality of simulations result in a range of numbers of transportation vessels required to meet a predetermined service level.

### CROSS-REFERENCE TO RELATED APPLICATIONS

The present application claims priority from U.S. patent application Ser. No. 16/413,464, filed on May 15, 2019, the disclosure of which is hereby incorporated by reference in its entirety.

### TECHNICAL FIELD

The present disclosure is directed to methods and systems for managing transportation vessels within a retail enterprise system.

### BACKGROUND

Retailers often have multiple nodes within an enterprise system. One such retailer network includes, e.g., distribution centers, flow centers (routing centers), and retail locations. The retailer is tasked with the job of maintaining appropriate inventory within each of the nodes and transporting inventory between the nodes as needed. In some instances, a retailer may own all or some of the transportation vessels needed to move inventory between nodes. In other instances, retailers rent some or all of the transportation vessels needed. Owning too many or too few transportation vessels results in increased costs and unused vessels.

Existing solutions optimizing or improving transportation vessel management can be made more difficult because demand for inventory items made changes over time. Further, the cost of transportation vessels depends on the ownership model for such transportation vessels, the distance between two nodes, and the time of transport between two nodes in a supply chain network. In view of the above-described challenges, managing transportation vessels that are used between multiple nodes in a retail enterprise system is an ongoing process in which improvements are continually sought and a static model is generally unsatisfactory.

### SUMMARY

In summary, the present disclosure relates to methods and systems for managing transportation vessels within an enterprise system.

In an example aspect, a method of managing transportation vessels within an enterprise system includes the following: a software tool implemented on a computing system receives inputs related to historical transportation vessel usage. The inputs include a historical demand level in a plurality of historical usage characteristics for each of a plurality of pairs of locations. A best fit distribution for each of the plurality of historical usage characteristics and historical demand is automatically determined from the historical transportation vessel usage information. Next, for each of the plurality of pairs of locations a plurality of simulations is performed. The plurality of simulations uses a randomly selected value for each of a plural characteristics. The randomly selected value is weighted according to the best fit distribution of the corresponding historical usage characteristics. Each of the plurality of simulations includes an output of a number of transportation vessels required to meet a demand for each pair of locations, such that, the outputs of the plurality of simulations resulting in a range of numbers of transportation vessels required to meet a predetermined service level.

In another example aspect, the system for managing transportation vessels within an enterprise system includes the following: a computing system including a data store, a processor, and a memory communicatively coupled to the processor, the memory storing instructions executable by the processor to execute the following steps. Receive input related to historical transportation vessel usage. The inputs include a historical demand level and a plurality of historical usage characteristics for each of a plurality of pairs of locations. A historical transportation vessel usage information and a best fit distribution is determined for each of the plurality of historical usage characteristics and the historical demand. For each of the plurality of pairs of locations, a plurality of simulations is performed using a randomly selected value for each of a plurality of usage characteristics. The randomly selected value is weighted according to the best fit distribution of the corresponding vessel usage characteristics. Each of the plurality of simulations includes an output of a number of transportation vessels required to meet a demand for each pair of locations, such that, the outputs of the plurality of simulations result in a range of numbers of transportation vessels required to meet a predetermined service level.

In a further aspect, a non-transitory computer-readable medium comprising computer-executable instructions, which when executed by computing system cause the computing system to perform a method of managing transportation vessels within an enterprise system. The method comprises receiving input related to historical transportation vessel usage. The inputs include a historical demand level and a plurality of historical usage characteristics for each of a plurality of pairs of locations. A historical transportation vessel usage information and a best fit distribution is determined for each of the plurality of historical usage characteristics and the historical demand. For each of the plurality of pairs of locations, a plurality of simulations is performed using a randomly selected value for each of a plurality of usage characteristics. The randomly selected value is weighted according to the best fit distribution of the corresponding vessel usage characteristics. Each of the plurality of simulations includes an output of a number of transportation vessels required to meet a demand for each pair of locations, such that the outputs of the plurality of simulations resulting in a range of numbers of transportation vessels required to meet a predetermined service level.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates a schematic diagram of an example supply chain for a retail enterprise.

FIG. 2 illustrates a schematic diagram of an example transportation vessel management system.

FIG. 3 illustrates a more detailed view of the modeler of FIG. 2.

FIG. 4 illustrates an example method of managing transportation vessels within a retail enterprise system.

FIG. 5 illustrates a histogram of historical demand inputs useable in managing transportation vessel allocations, in accordance with an example embodiment.

FIG. 6 illustrates a best fit model for historical demand inputs of FIG. 5.

FIG. 7 illustrates an example graphical representation of one of the historical inputs.

FIG. 8 illustrates an example best fit historical model for transit time, dwell time, and demand.

FIG. 9 illustrates an example method of conducting a synthetic distribution process to generate a forecast output.

FIG. 10 illustrates a graphical representation the number of vessels needed per node pair.

FIG. 11 shows an example user interface for managing a transportation vessel system.

FIG. 12 illustrates an example block diagram of a computing system useful for implementing the transportation vessels management system.

FIG. 13 illustrates a schematic diagram of an example transportation fleet management system.

FIG. 14 illustrates an example method of selecting an optimized cluster.

FIG. 15 illustrates an example block diagram for data collection.

FIG. 16 illustrates an example diagram showing clustering of locations based on demand

FIG. 17 illustrates an example flowchart for predicting an optimum enterprise-wide transportation fleet size.

FIG. 18 illustrates a flowchart for performing a simulation.

FIG. 19 illustrates an example distribution of drop volumes for stores within a determined cluster, according to an example embodiment.

FIG. 20 illustrates an example flowchart to determine the number of transportation vessels needed, in a further alternative embodiment

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

An enterprise system of the present disclosure utilizes an architecture of established retail sites, established flow centers associated with the retail sites, established receive centers for receiving product from vendors, and established hauling routes between receive centers, retail sites, and flow centers, herein referred to as “nodes.” The transportation vessel management system uses dynamic, stochastic modeling to determine a minimum number of transportation vessels required to meet a predetermined service level, e.g., to ensure that a predetermined transportation capacity is met at least a threshold amount of time based on anticipated need to move items between two nodes in a supply chain network.

The transportation vessel management system is, in some embodiments, implemented on a data communication network that serves as a center for coordination of shipments between two enterprise nodes. In some embodiments, the system includes a collection of functions and features implemented in software and/or hardware that make the operation and management of transportation vessels as an automated process.

In general, the present disclosure relates to methods and systems for determining an optimized number of transportation vessels to meet a predetermined service level. The service level measures the performance of the system in meeting the delivery demands in a timely manner. In an example, a predetermined service level is 98%; however, other service levels are envisioned (e.g., 99%, 95%, 80% etc.). In some instances, the predetermined service level can be set by a user prior to optimization, and is freely configurable at any percentage service level. Additional features that may be considered when determining the number of transportation vessels needed include ownership costs, rental costs, leasing costs, currency and/or exchange rate fluctuations, fuel costs, transportation vessel size, and utilization rate. The selected number of transportation vessels used to meet the predetermined service level includes an optimum number of vessels while minimizing costs.

The methods and systems described herein provide efficiencies in transportation vessel usage by maximizing usage and minimizing downtime, ensuring that physical vessels are procured and coordinated between nodes to move goods between a set of nodes as efficiently as possible.

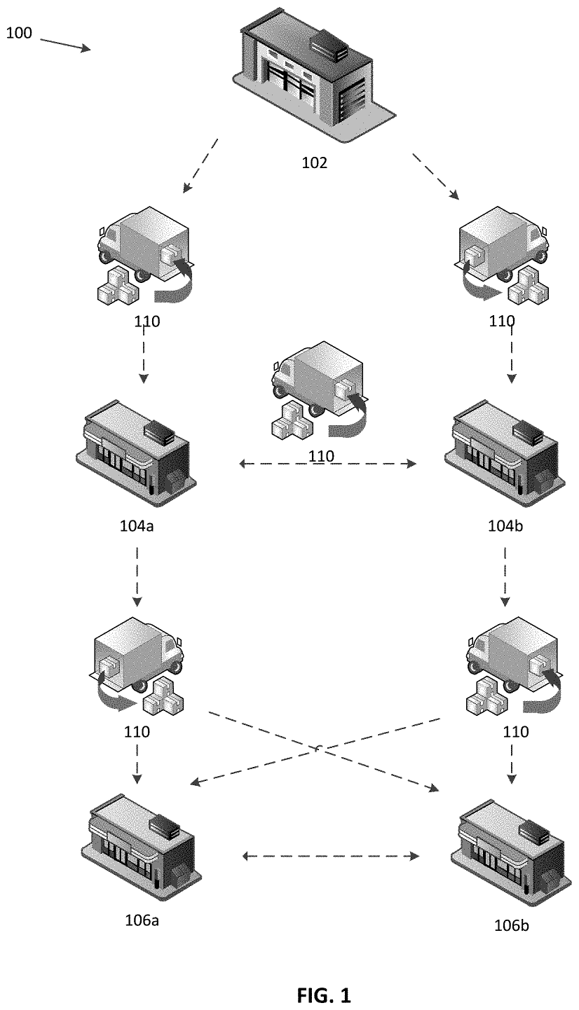

FIG. 1 illustrates a schematic diagram 100 of an example supply chain for a retail enterprise. The diagram 100 illustrates the flow of inventory from vendor 102 to retail locations 106. The inventory moves through various nodes to arrive at the customer. In this example, the nodes include a vendor 102, two distribution centers 104a, 104b, and two retail stores 106a, 106b. In practice, the supply chain could include many more nodes, including flow centers, and in different proportions. In some embodiments, there are additional and separate receive centers and flow centers that house inventory between vendor and retail store. Arrows in the diagram indicate movement of inventory. Inventory will typically flow downward through the supply chain, but in some instances inventory may move between distribution centers 104a, 104b and retail stores 106a, 106b.

Transportation vessels 110 move inventory between nodes. A first transportation vessel 110 may move inventory from vendor 102 to distribution center 104a. The same or a different transportation vessel 110 may move inventory from one retail store 106a to another retail store 106b. Still further, transportation vessels may be used to move inventory items between other nodes, such as between distribution centers 104a, 104b.

Vendor 102 produces/provides the items or products that will be sold by the retail entity. In some instances, the vendor 102 will transport the ordered products to a node within the retail enterprise. In other instances, the retail enterprise arranges for the inventory to be picked up from the vendor 102 and transported to the desired node. The inventory items may be transported in a variety of different transportation vessels 110. Example transportation vessels 110 include, but are not limited to, tractor-trailers, shipping containers, cargo ships, and aircraft cargo. Still further, different sizes and specialties (such as vessels including specialty equipment, such as refrigeration) for each of the transportation vessels are considered. Throughout this application, trailers are referred to as the transportation vessel 110, but this is not to be seen as limiting.

It is noted that, between distribution centers 104a, 104b, and retail stores 106a, 106b, there may be preexisting, predetermined delivery routes established. For example, there may be daily or weekly transit routes between a distribution center and one or more retail stores. The distribution center can provide to the retail location the selection of individual items that are needed by retail stores 106a, 106b serviced by the one or more distribution centers 104a, 104b proximate to and/or servicing those stores. The distribution centers 104a, 104b can also have daily or other periodic transportation routes established to retail stores 106a, 106b that are serviced, thereby ensuring prompt replenishment of items at retail stores 106a, 106b in response to demand.

In the context of the present disclosure, a transportation vessel management system is provided that assists in coordination of product shipments among and between nodes of the supply chain, and uses predictive models to automatically determine a optimization of total capacity of transportation vessels required to be allocated according to one or more allocation models (e.g., buy or rent). In some instances, the optimization corresponds to an overall number of transportation vessels, as well as a ratio of transportation vessels across allocation models within the supply chain of the enterprise to ensure a demand between each pair of locations within a forecast time period and service level are met. Accordingly, as noted below, substantial advantages are realized using the methods and systems of the present disclosure.

It is in a general supply chain retail environment that the following systems and methods operate. While the methods and systems are described in a retail environment having brick-and-mortar stores as well as online sales, additional applications are possible. For example, the systems and methods could operate for distribution channels that distribute supplies to multiple locations within a business that does not have retail locations.

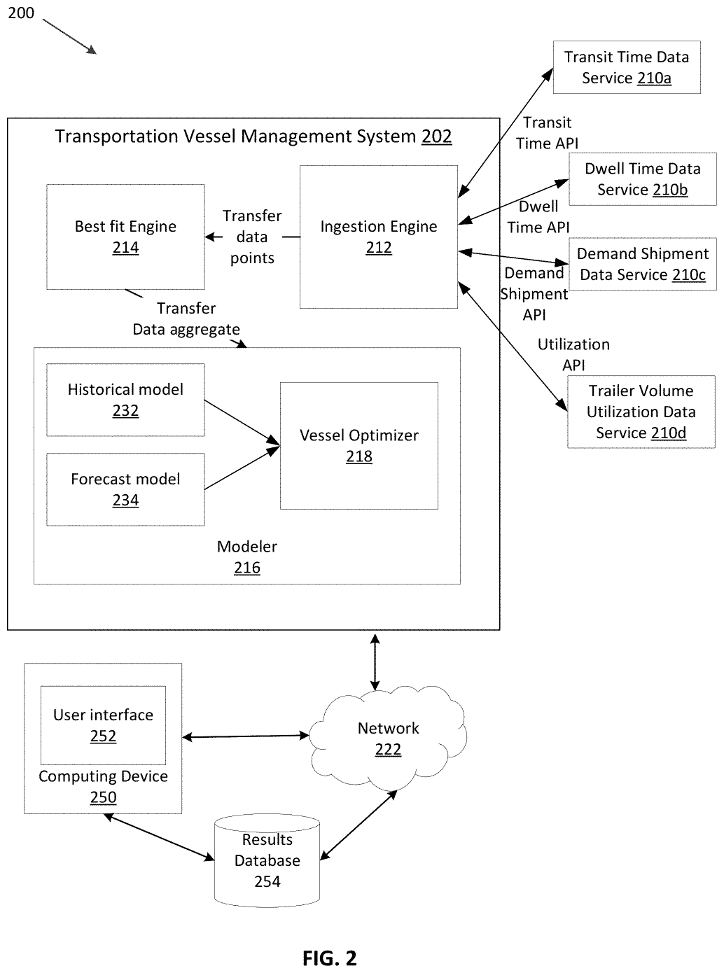

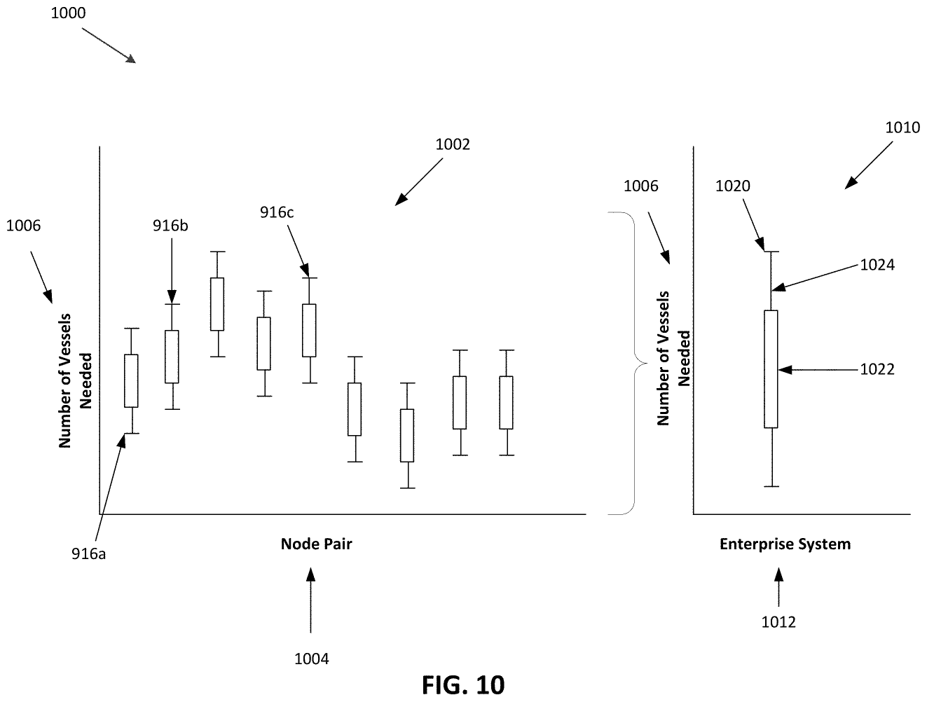

FIG. 2 illustrates a schematic diagram of an example system 200 for implementing a transportation vessel management system 202. The transportation vessel management system 202 can be implemented in the form of a software tool executable on a computing device, such as the device seen in FIG. 10. Components of the of the transportation vessel management system 202 include an ingestion subsystem 212, a best fit engine 214, a modeler 216, and a vessel optimizer 218.

Each input received and each output provided is based on a pair of locations. The process described below is conducted on a per-pair-of-nodes basis.

The ingestion subsystem receives inputs from a transactional database, such as the data services 210a, 210b, 210c, and 210d. The transit time historical inputs are received by a transit time data service 210a, which is called by the transit time API after receiving a request from the ingestion subsystem 212. The dwell time historical inputs are received from the dwell time data service 210b by calling a dwell time API after receiving a request from the ingestion subsystem 212 Demand shipment historical inputs are received from a demand shipment data service 210c, which is called by a demand shipment API after receiving a request from the ingestion subsystem 212. The trailer utilization inputs are received by a trailer utilization data service 210d, which is called by the utilization API after receiving a request from the ingestion subsystem 212.

Transit time historical inputs are defined as the time that it takes a transportation vessel to travel between a pair of notes. In an example, the transit time may be measured in minutes, hours, days, or weeks.

Dwell time historical inputs are defined as the time that a transportation vessel is not in transit. For example, dwell time includes the unload time at a destination location as well as the load time at origination location. Further, dwell time may include time that the transportation vessel is undergoing maintenance work, or is not being used (underutilization). Dwell time may also be measured in minutes, hours, days, or weeks.

Demand shipment historical inputs are defined as volume by class of product that is required to be shipped per week. Demand shipments are sorted by product class because different products may require a different type of transportation vessel. Demand shipments may be measured based on a volume class.

Trailer volume utilization inputs are defined as the percentage full an individual trailer is during a single route. A threshold may be 65% space utilization. For example, if a vessel volume is 1000 cu. ft., then 650 cu. ft. of the vessel is filled if the trailer volume utilization is 65%. Alternatively, the utilization may be a distribution within a predefined range, such as 50-70%. The historical values are obtained and a distribution is fit in a similar process as the other parameters.

In response to receiving the inputs, ingestion subsystem 212 provides the data to the best fit engine 214. The best fit engine 214 analyzes the data individually to determine a range and variance of the data within a historical time frame. Such analysis can include, for example, plotting the data graphically or mathematically. This process is repeated for each input received. If enough data is not received by best fit engine 214 to determine a range and variance, best fit engine 214 requests additional inputs from ingestion subsystem 212. If additional inputs are not available, ingestion subsystem 212 can call either of the transit time API, dwell time API, demand shipment API, or utilization API to request inputs from a longer period of time. In a first example, the last six months of data points may be received from the transit time data service 210a. However, if there is not enough data in the last six months, ingestion subsystem 212 may request data points from the last two years. The last six months of dwell time data points may be initially gathered by ingestion subsystem 212 and sent to best fit engine 214. The last two years of demand shipment data points may be initially gathered by ingestion subsystem 212 and sent to best fit engine 214. However, more or less time may be used to gather data points as needed. Alternatively, if there are not enough data points gathered, the best fit engine 214 fits a default distribution with derived parameters.

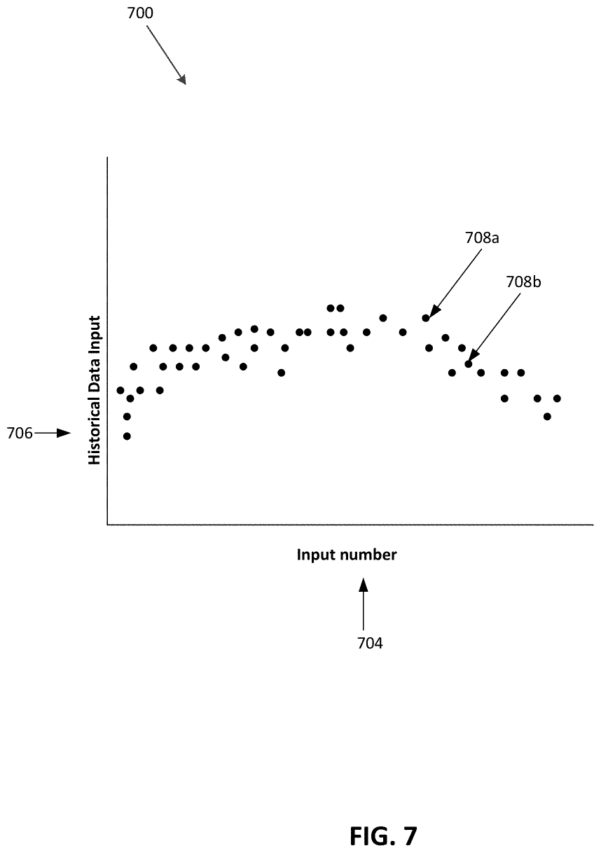

After best fit engine 214 determines a range and variance for each of the inputs individually, the best fit engine 214 provides an output (a set of data aggregates) to the modeler 216. The modeler 216 uses this information to create both a historical model 232 based on the input scenarios and a forecast model 234. The historical model 232 provides a model for each of the inputs individually, as well as the ability to overlay all of the imports into a single model. This is shown in more detail at FIG. 7.

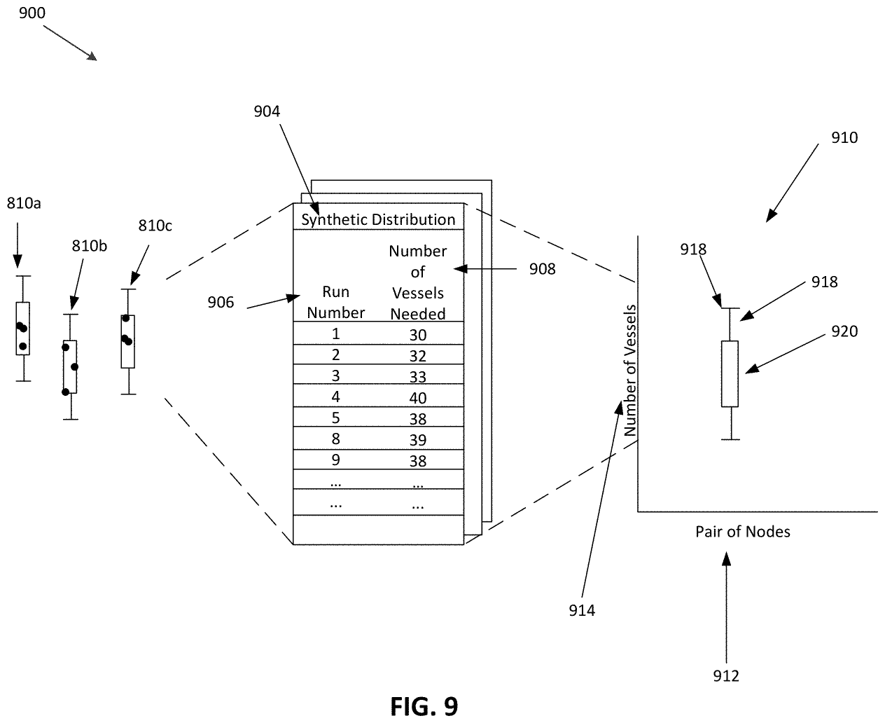

The modeler 216 includes the forecast model 234 and the historical model 232. The forecast model 234 and the historical model 232 utilize the same stochastic inputs to provide a prediction of the number of transportation vessels needed to reach a predetermined service level based on the historical inputs. The historical model 232 uses multiple demand scenarios generated from historical inputs by the best fit engine 214. The forecast model 234 uses demand inputs from a separate demand forecast model and has a single demand input. This process is described in more detail at FIG. 9.

The modeler 216 includes a vessel optimizer 218, which receives historical model 232 and a forecast model 234, which receives a single demand input. The vessel optimizer 218 outputs an optimum transportation vessel number to meet an optimum service level and a minimum cost. In a first example, the optimum service level is 98%. In another example, the optimum service level may be 95% or a lesser amount such as 90%.

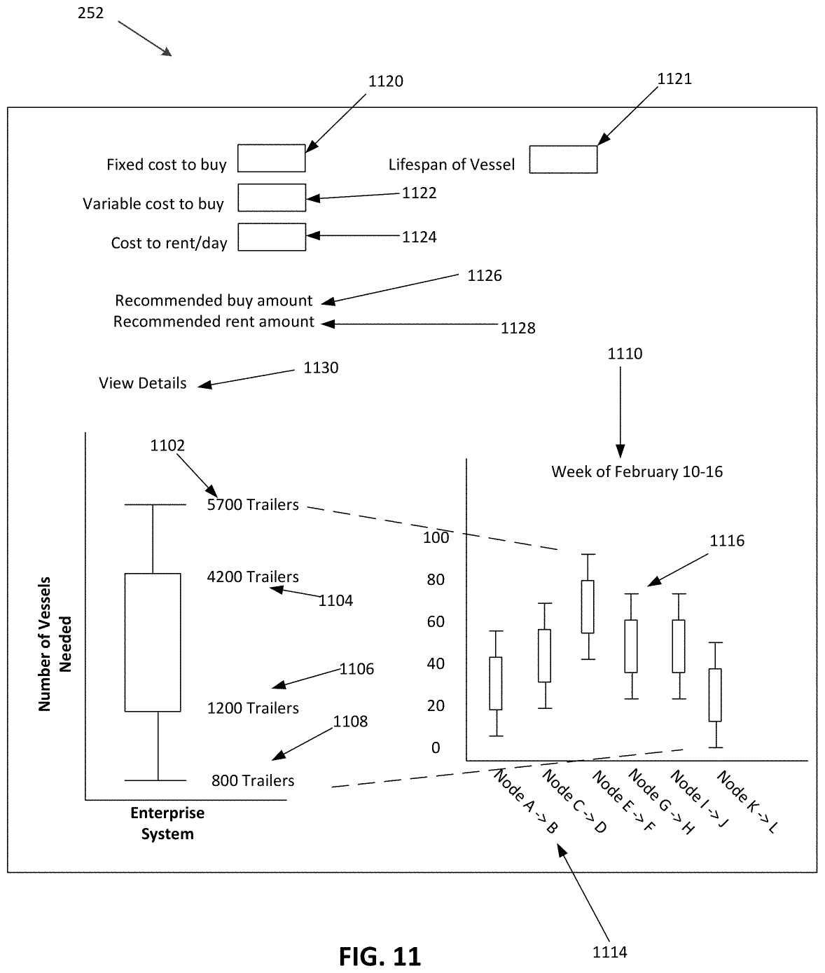

The vessel optimizer 218 also utilizes other factors to determine the optimum number of transportation vessels needed. Other factors include vessel types, vessel ownerships, vessel sizes, and transportation costs. Transportation costs include ownership costs such as maintenance costs, storage costs, and other costs associated with owning a transportation vessel. Transportation costs may also include rental costs, which are dependent on where the transportation vessel is needed, how long the transportation vessels is needed, and how far it travels. FIG. 11 illustrates an example for inputting such factors. The vessel optimizer 218 uses a stochastic model to determine the optimum ratio of owned and rented transportation vessels, since the historical inputs and other factors change over time.

The vessel optimizer 218 provides an amount of transportation vessels needed to meet the service level requirement to a user interface 252 of a connected computing device 250 via the network 222. The output provided by the vessel optimizer 218 is also communicated with a results database 254. The results database 254 can be accessed via the network 222 by the transportation vessel management system 202 and the computing device 250. As described in more detail below at FIG. 11, a user can input factor values, which are used to determine the recommended number of transportation vessels needed. The user interface 252 can be viewed by an administrative user of the transportation vessel management system 202 for implementation. In an example, the user interface 252 can provide a user with access to view and implement the recommended number of transportation vessel needed between a pair of nodes. In some examples, a user can view the recommended number of transportation vessels per type, size, or ownership. Still further, a user can view detailed information about transportation vessels, such as purchase date, rental date, maintenance schedules, and other similar information on a per-vessel basis.

The transportation vessel management system 202 communicates with a computing device 250 through a network 222. The network 222 can be any of a variety of types of public or private communications networks, such as the Internet. The computing device 250 can be any network-connected device including desktop computers, laptop computers, tablet computing devices, smartphones, and other devices capable of connecting to the Internet through wireless or wired connections.

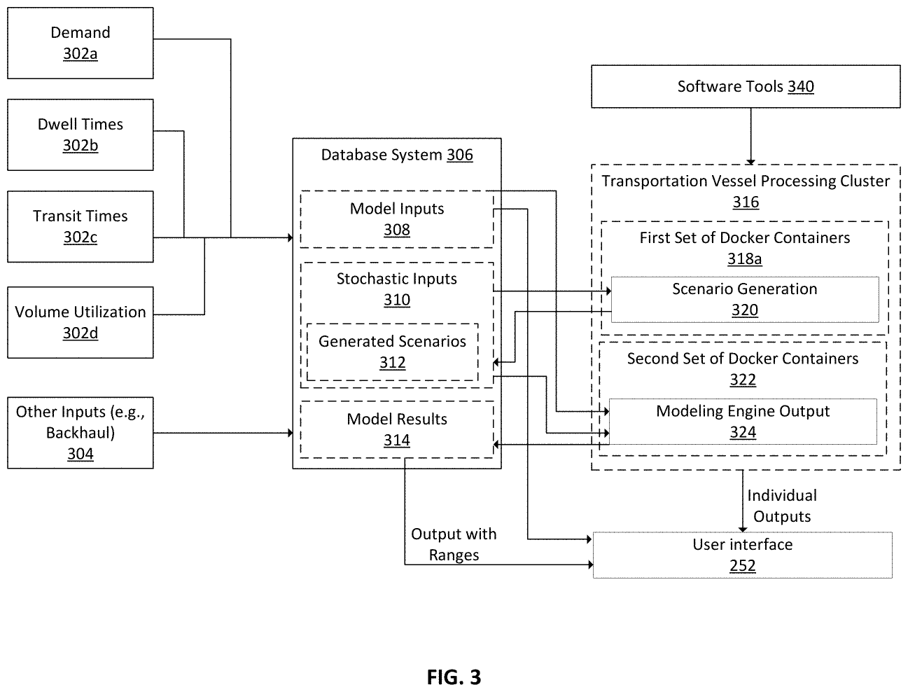

FIG. 3 illustrates a more detailed example system of modeler 216. Modeler 216 includes receiving data inputs, processing them at a database system 306 and a transportation vessel processing cluster 316, and providing an output to the user interface 252.

Data inputs selected from demand 302a, dwell times 302b, transit times 302c, and trailer utilization 302d (collectively referred to as “inputs 302”) are entered into the database system 306. Other inputs 304 include rental cost, fixed owned cost, and variable owned costs and are also entered into the database system 306. Unlike data inputs 302, which are taken from historical data, other inputs 304 may be entered by a user. Other inputs 304 include rental costs and ownership costs. Rental costs include the cost to rent a transportation vessel for a predetermined transit route (or distance) for a predetermined time, and for a type of vessel. Fixed ownership cost includes the initial cost of the transportation vessels, and variable owned costs include upkeep costs such as maintenance and storage.

The data inputs 302a, 302b, 302c, 302d and the other inputs 304 are fed to the database system 306. Database system 306 includes deterministic inputs 308, stochastic inputs 310 leading to generated scenarios 312, and model results 314. As described above, together these systems generate historical models and forecast models.

Transportation vessel processing cluster 316 allows containerized software workloads to be deployed for, e.g., analysis and reporting. In the example shown, the cluster 316 includes a first set of docker containers 318 that includes a scenario generator 320 and a second set of docket containers 322 that includes a modeler 324. Different software tools 340 are utilized by transportation vessel processing cluster 316 to run overall models and generate outputs to be sent to a user interface 252. It is noted that other containers could be used as well, and that separate containers can be used for purposes of scenario generation and modeling on a per-scenario, per-node-pair, per-region, overall, or some other logical basis. However, in the example shown, first and second containers are illustrated because a scenario generation stage and a modeling stage are performed in example embodiments described in further detail below.

In the embodiment shown, database system 306 provides deterministic inputs 308 to both modeler 324 and user interface 252. Stochastic inputs 310 are passed from database system 306 to scenario generator 320. The scenario generator 320 generates scenarios based on the information stored in the database system 306. In example scenarios, and as discussed further below, the scenario generator 320 will generate scenarios by randomly selecting parameters from a weighted distribution defined in the stochastic inputs 310, and generated scenarios are returned to the database system 306.

Generated scenarios 312 are passed to a modeler 324, which will optimize the mathematical construct with input scenarios and provide a number of transportation vessels required for the scenario to be tested. Model results 314 are passed to user interface 252. Scenario generator 320 also passes information back to generated scenarios 312 and modeler 324 passes information back to model results 314, which provides information to the user interface 252.

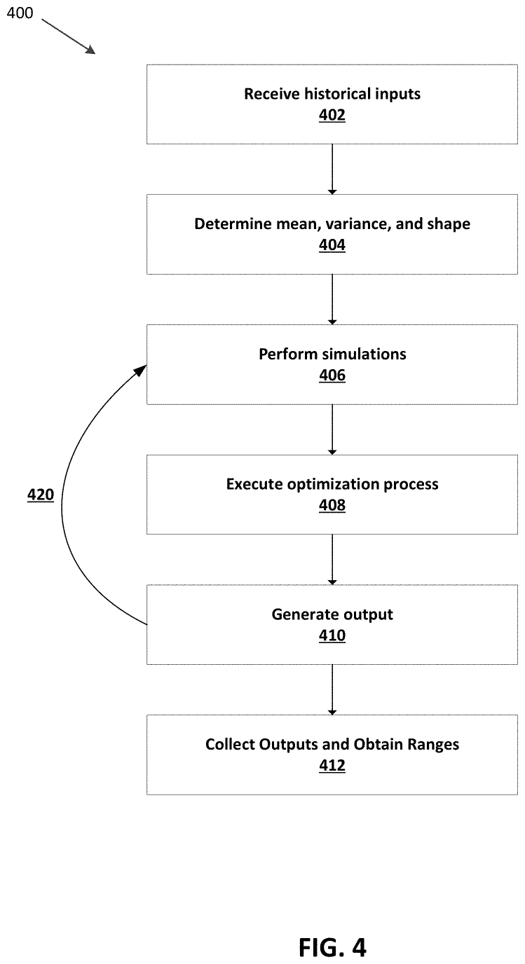

FIG. 4 illustrates an example method 400 of generating an output for managing transportation vessels within an enterprise system. As described in more detail below, steps 402, 404, and 406 are performed individually for each of the historical transportation vessel usage information inputs. At step 408, the information gathered from steps 402, 404, and 406 is used to execute an optimization process, and at step 410, an output is provided.

At step 402, a first historical input is received. A historical input is selected from a transit time, demand shipment, a dwell time, and a trailer volume utilization. Additional inputs may be considered as needed. Transit time between a pair of locations is defined as the time that the transportation vessel is in route between each the pairs of locations. Transit time is the time it takes the transportation vessel to travel between the first location and the second location, taking into consideration factors such as traffic, weather, and other similar things that may affect the time it takes for the vessel to travel between the first and second location. Historical information is gathered from the last 6 months of data currently available. Further, the inputs are dynamic, and may be continuously received and updated. Additionally, transit time between a pair of nodes may be affected by the route taken. In a typical case where a transportation vessel is loaded with goods and traveling between nodes (e.g., between a distribution center and a store), this corresponds to the distance between those nodes, plus time for hook/unhook operations for the trailer. However, for backhaul loads, this may include not only the backhaul time, but any time required to travel out of the way for purposes of performing out-of-route backhaul deliveries for third parties. A post-processing method is used to determine backhaul time to improve accuracy of the results being reported.

Demand shipment is defined as volume by class of product that is required to be shipped per week. Demand shipments are sorted by product class because different products may require a different type of transportation vessel. For example, some food products need to be transported in a refrigerated vessel, while clothing items can be transported in a standard vessel. Further, large products may need to be shipped in a larger transportation vessel, while other products may fit in a smaller transportation vessel.

Dwell time is defined as the time the transportation vessel is not being used. For example, dwell time includes the unload time at a destination location as well as the load time at origination location. Further, dwell time may include time that the transportation vessel is not being used (underutilization).

The historical inputs are calculated as time or demand between a pair of locations. As shown in FIG. 1, pairs of locations may be between any two nodes, such as a vendor and a retail location. Information from established transportation routes is gathered, and can be used to predict future times along the established transportation routes, as well as new routes.

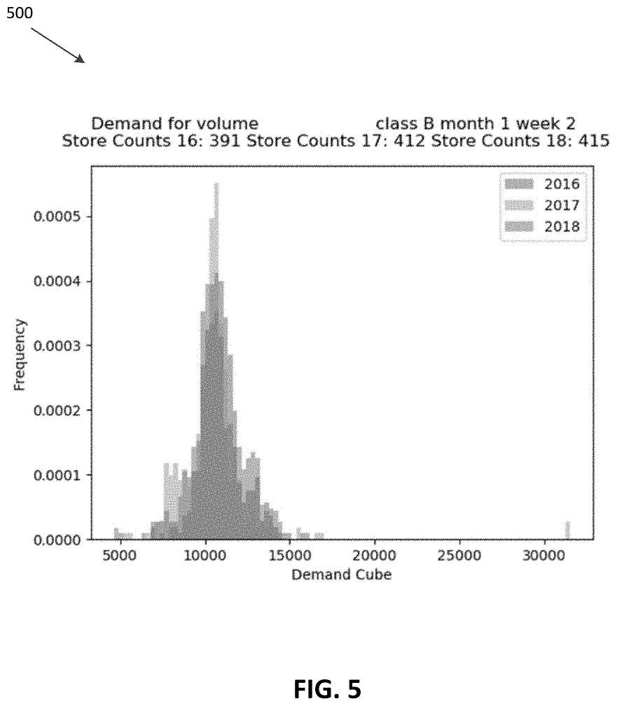

The transit time between a plurality of pairs of locations is gathered and plotted independently of the other historical inputs. Demand shipments between a plurality of pairs of locations is also gathered and plotted, and dwell times for a transportation vessel at each of the plurality of location is gathered. Each of these sets of historical information is gathered individually and independently on the pairs of locations. A schematic example of such information is shown as a plot at FIG. 7; alternatively, a histogram of such data (in particular, demand shipments) is seen in FIG. 5.

Other factors that may affect historical inputs include information such as inventory type, type of transportation vessel (such as trailer, truck, and size of vessel), location of transit route (such as city or rural), time of year (such as holiday), and other similar inputs that contribute to the variation of inputs.

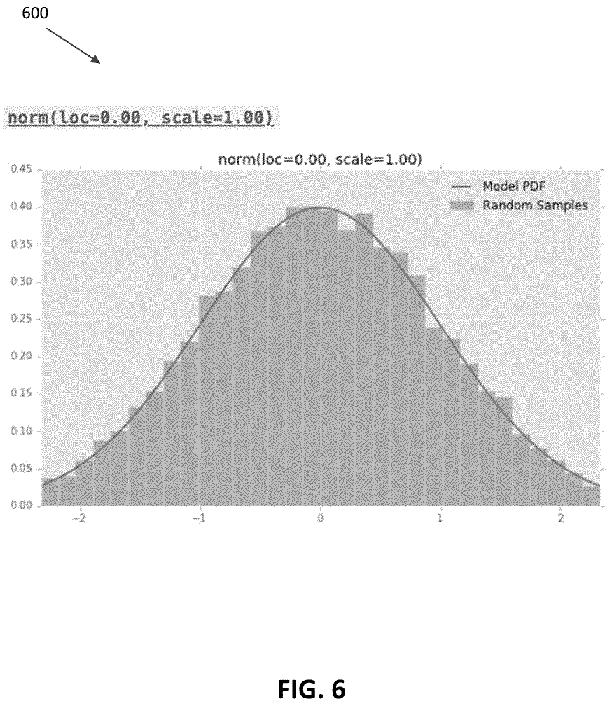

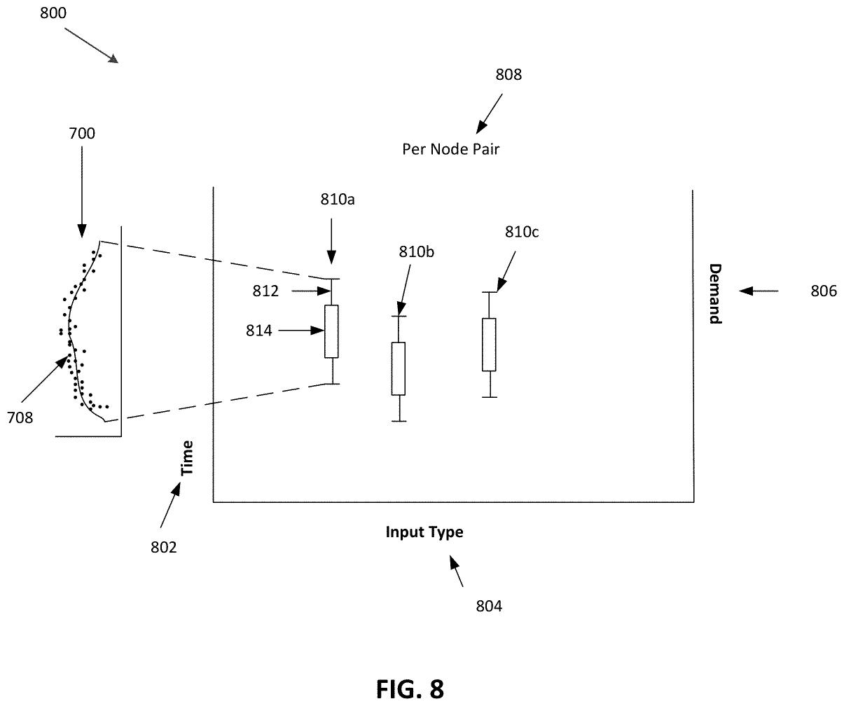

At step 404, a best fit distribution is determined. The best fit is determined using the historical transportation vessel usage inputs and a best fit is provided for each of the plurality of historical usage inputs. This is shown in more detail at FIG. 8, with a particular best fit model for the demand inputs of FIG. 5 seen in FIG. 6. A best fit distribution identifies a mean, range, and variance parameters.

At step 406, a simulation using a randomly-selected value is performed for each of the inputs between each of the plurality of pairs of locations. The randomly-selected value is randomly generated and is selected by a weighting defined according to the best fit distribution of the corresponding historical usage characteristics. Each of the plurality of simulations generates an output individually for each of the historical inputs.

After the best fit distribution and simulations are performed for the first historical input, the process is repeated, for each of the other historical inputs. In an example method 400, steps 402, 404, and 406 are repeated for a total of three times.

In an example, the simulation is performed 50 times, while randomly selecting variable values in accordance with the distribution for each variable, e.g., weighted according to the best fit determination, which is used to predict future scenarios.

At step 408, an optimization process is executed. The optimization process determines an optimal (e.g., minimum) number of transportation vessels required to meet a predetermined service level. The minimum number of transportation vessels includes a distribution of transportation vessels types, sizes, and ownership type. The optimization process can also take into consideration inputs added by a user, including ownership costs and rental costs, in order to optimize the usage of owned transportation vessels and minimize costs.

TABLE 1
Rental Model Input Table for Transportation Vessels

| Transportation Vessel | | | | |
|---|---|---|---|---|
| Type | Daily | Mileage | Free Miles | Hours |
| Reefer, 48′-53′ | $50 | $0.04 | | $1.00 |
| Reefer, 48′-53′, Lift Gate | $60 | $0.08 | | $1.00 |
| Van, Road, 28′ | $10 | $0.04 | | |
| Van, Cartage, 48′-53′ | $8 | $0.04 | 100 | |

TABLE 2
Example Owned Model Input Table for Transportation Vessels

| Vessel Type | Purchase Cost | Annualized Cost | Maintenance |
|---|---|---|---|
| Reefer, 48′-53′ | $100,000 | $10,000 | $5,000 |
| Reefer, 48′-53′, Lift Gate | $120,000 | $12,000 | $6,000 |
| Van, Road, 28′ | $30,000 | $2,000 | $1,500 |
| Van, Cartage, 48′-53′ | $28,000 | $1,800 | $1,500 |

It is also noted that not all vessel types may be available for rental. Accordingly, optimization determines (1) what vessel types are required or useable for a particular anticipated demand load at a particular time, and (2) the cost-optimized breakdown of vessel types and ownership models for those vessel types given the anticipated demand and possible variance in demand. Example methodologies for performing vessel optimization are discussed in further detail below.

At step 410, an output is generated. In example embodiments, outputs are generated for each optimized scenario, including those generated from historical models and from a forecast model. The historical model uses historical demand scenarios, and the forecast model uses a single forecasted demand input. Use of historical models and forecast models allows for improved decision making, while minimizing modeling errors through triangulation of results from each of the models.

The output for each model includes a number of transportation vessels required to meet a demand for each pair of locations within a forecast time period. The output recommends an optimum distribution of transportation vessel types. Types of transportation vessels includes different sizes and specialties. Different specialties include standard, refrigeration, freight, lift gate, and dry.

After an output is generated for a first historical input, the simulation and optimization processes are repeated 420. In particular, for each simulation, an optimization process is performed and an output is generated, such that optimized outputs are generated for each simulated scenario (both historical and forecast). After the process has been repeated 420 an appropriate number of times (e.g., up to or exceeding 50 iterations on different scenarios), at step 412, all of the inputs are collected and a range of optimized outputs is obtained. Accordingly, a distribution can be provided that represents a range of possible numbers of transportation vessels and optionally a confidence interval that a particular range or value will meet a particular, predetermined service level.

Referring now to FIGS. 5-6, a specific graphical representation of historical demand data is seen in accordance with use of a best fit model for that demand data. In FIG. 5, a graph 500 showing the demand for volume in transportation vessels is seen for a particular week. In this example, demand is shown across three different years to accommodate changes in demand historically.

In the example shown in FIG. 5, a histogram 500 depicts frequency of demand levels over the course of a hear. As seen in that histogram, typical demand levels across an enterprise will fall within a predetermined band between 7000-15000 cube units (arbitrarily, but constant sized units used for vessel capacity planning). Accordingly, as reflected in FIG. 6, a modeled curve 600 can be extrapolated from a normalized, scaled version of the histogram spread over time, such that such a distribution curve can be applied to future planned demand. In other words, although overall demand may differ in an upcoming year as compared to existing years (e.g., due to location openings/closings, changes in stock that is carried, etc.), it can be expected that the variability in demand over the course of the year may remain similar to previous years. Based on such a modeled demand (or other modeled variables, such as transit times, or other types of data inputs) simulations may be performed to determine a best allocation of transportation vessels to meet demand up to a predetermined service level.

FIG. 7 illustrates a further example graphical representation 700 of historical input data. This historical input data may include data points 508a, 508b. For illustrative purposes, transit time is described as the input data; however, it should be noted that the same process is repeated for the transit time between different nodes as well as the dwell time and trailer volume utilization at each of the nodes, as well as the demand between each pair of nodes. The data points shown on the graph represent the time it takes a transportation vessel to travel between a pair of nodes. Still further, although in FIG. 7 raw data is shown, this may equivalently be depicted as a histogram for purposes of obtaining a best fit to the historical data.

While only the transit time, dwell time, and demand shipment are shown and described in FIGS. 5-9, the inclusion of other inputs is within the scope of this disclosure. For example, utilization may be included as an input.

For the transit time historical input, the historical data input value 706 corresponds to a transit time, and the input number value 704 corresponds to a single trip between the pair of nodes. In an example, the trips between the pair of nodes are organized based on date. The data points 708a, 708b represent the historical transit times between each of the pairs of locations. The transit time inputs may be collected from at least the last 6 months of available data. In another embodiment, the transit time inputs may be collected from the last two years of available data.

Still further, transit time historical information may be plotted based on more specific factors, for example vessel type between a pair of locations. The vessel type may further be distinguished based on vessel size, vessel location, and vessel ownership.

For the dwell time historical input, the historical data input value 706 corresponds to a dwell time, and the input number value 704 corresponds to a dwell time for a transportation vessel after completing a trip between two nodes. The dwell time inputs may be collected from at least the last 6 months of available data. In another embodiment, the dwell time inputs may be collected from the last three years of available data. Similar to transit time, dwell time may also be further plotted based on one or more of the specific factors stated above.

For the demand shipment historical input, the historical data input value 706 corresponds to a volume class, and the input number value 704 corresponds to a single trip between the pair of node. A volume class may be different types of products sold by the enterprise system, and may be divided by different methods. In a first example, a volume class is dependent on the supplier. In another example, the volume class is dependent on shipping requirements, such as refrigeration. The volume class inputs may be collected from at least the last 6 months of available data. In another embodiment, the volume class inputs may be collected from the last two years of available data.

The data points gathered are sent to the best fit engine, where the best fit engine determines the statistical distributions for each input. The mean, variance, and range parameters are estimated from the observed data points 708. This process can be repeated for various distributions and the best-fit distributions are selected. As noted above, in some examples, data points are organized into a histogram for purposes of determining a best-fit.

FIG. 8 illustrates an example best fit historical model for transit time, dwell time, and demand. Each of the graphical representations 700 (or distributions, such as in FIG. 5) for the inputs is used to create each of the data aggregates 810a, 810b, and 810c. A normalized best fit model 800 is created on a per-node basis, so a different model 800 is created for each pair of nodes. Still further, the best fit model 800 is specific to a historical time period, and may be updated periodically or on an as-needed basis.

Generally, FIG. 8 illustrates a graphic depiction of distributions of each of the inputs, normalized, and shown on a single model 800 on a per node pair basis. The data aggregates 810a, 810b (transportation time and dwell time) are based on time 802, while aggregate 810c (demand shipment) is based on demand 806.

Each of the inputs is shown as a data aggregate 810a, 810b, 810c, is shown having a range 812 and a variance 814. The range and the variance reflect variations within the collected data (e.g., from the plotted data points 708). For example, plotted data points 708 are shown as contributing to data aggregate 810a. Data aggregate 810b and data aggregate 610c are also/alternatively created using their respective data points 708.

In the example implementation shown, the data points collected for each individual input can be used to create a range 812 and variance 814 between each node pair. The range 812 and variance 814 may represent differing proportions of the data points. In a first example, the variance 814 represents 80% of the data points, and the range 812 represents all data points. In another example, the variance 814 represents 50% of the data points, and the range 812 represents 80% of the data points, which leaves the outlying 20% of data points are unneeded. However, any percentage or proportion may be used to represent the range 812 and variance 814.

As noted above, each of the data aggregates 810a, 801b, 810c represent data points on a per-node basis. A per-node basis can be between any two nodes within the enterprise system, so long as each of the data aggregates plotted together are for the same pair of nodes.

In example embodiments, a graphical distribution model 800 is made for each of the node pair combinations. It is noted that in the context of the present disclosure, a large number of data points may be collected for each node pair in a supply chain network, and a large number of node pairs may exist as well. As such, it may be difficult to directly use all of the data aggregates for purposes of optimization of transportation vessel capacity, due to processing constraints.

FIG. 9 illustrates an example method 900 of conducting a synthetic distribution process to generate a forecast output. Generally, the synthetic distribution process generates a distribution of needed transportation vessels based on a stochastically-weighted selection of experimental values used to generate scenarios, which in turn generate a required number or selection of transportation vessels to meet a predetermined service level. The method 900 performs such scenario-based experiments to avoid having to perform optimization calculations on each possible outcome of the possible outcomes due to actual data as to each node pair, thereby reducing the amount of processing time required to generate a representative model of transportation vessels required to meet the predetermined service level.

In the example embodiment, a modeler obtains the data aggregates 810a, 810b, 810c created by the historical model. Data aggregates 810a, 810b, 810c are used to determine a number of transportation vessels needed to meet a predetermined service level. Additionally, forecast model data can be used as well for purposes of simulation and optimization, to determine the number of transportation vessels required. In example embodiments, the data aggregates 810a-c may be created from either or both of the historical model and the forecast model.

For each of the inputs, a synthetic distribution 904 model is run. While only one set of results is shown, the synthetic distribution 904 model is run for each input for each pair of nodes. In the example shown, the number of vessels needed to meet a predetermined threshold level is determined. In an example, the predetermined service level is selected as 98%; however, any predetermined service level may be considered.

The synthetic distribution 904 model is run for the input data aggregates 810a, 810b, 810c. As shown in the example, at least seven runs 906 are conducted in the synthetic distribution 904 model, and the number of vessels needed 908 is determined. In an example, 50 runs 906 are conducted by synthetic distribution 904 model for each node pair. In other examples, other numbers of experimental runs maybe performed.

The results from the synthetic distribution 904 model is shown in graph 910. The graph 910 plots the number of vessels 914 needed per pair of nodes 912. The number of transportation vessels needed is shown as a data aggregate 916 including both a range 920 and variance 918. The data aggregate 916 is representative of a range of a predicted number of vessels needed between each pair of nodes. The data aggregate 916 also illustrates the highest and lowest number of transportation vessels needed between a pair of nodes.

FIG. 10 illustrates an overview 1000 of a graphical representation 1002 of the number of transportation vessels needed on a per node basis and a graphical representation 1010 of the number of transportation vessels needed for an enterprise system 1012.

The graphical representation 1002 shows data aggregates 1016 representing the number of vessels needed 1006 per node pair 1004 based on the predictions from the synthetic distribution model. Each data aggregate 916a, 916b, 916c is used to represent the maximum and minimum number of vessels needed between each node pair 1004 as well as the range and variance of vessels needed between each node pair 1004. The minimum and maximum number of transportation vessels needed could be used to further distinguish the type of transportation vessels needed at a node pair.

The graphical representation 1002 is also used to illustrate the different needs of different node pairs. For example, the third node pair requires a higher minimum than the maximum of the seventh node pair.

The distribution of data aggregates 916 may also be aggregated to a single data aggregate 1020 that represents the total number of vessels needed 1006 across an enterprise system 1012. The data aggregate 1020 includes a range 1022 and variance 1024. This information illustrates the need across the entire enterprise system and may be used to determine how many transportation vessels should be owned by an enterprise system. For example, the enterprise system may purchase at least the minimum of the range of the number of transportation vessels because it is more than likely that these transportation vessels are needed.

The vessel optimizer uses equation 1 to determine the optimum number of transportation vessels needed. In order to minimize the underutilization of transportation vessels, equation (1) is utilized to predict the optimum number of transportation vessels based on the stochastic inputs. The objective function of Equation (1) is to minimize the total costs and maximize the service level attained. Equation (1) takes into consideration the cost of movement of both rented and owned transportation vessels (Cₘ), the cost of owning and renting both loaded and empty transportation vessels (Cₒᵣ), the cost of holding empty transportation vessels at distribution centers (Cₕₑ), the cost of holding transportation vessels at retail locations (Cₕᵥ), and the cost of unmet demand (C_{ud}).

[Cₘ+Cₒᵣ+Cₕₑ+Cₕᵥ+C_{ud}] Eq. (1)

FIG. 11 shows an example user interface 252 including inputs from a user and outputs provided by the transportation vessel management system 202.

In order for the transportation vessel management system to determine an optimum number of transportation vessels needed, and to further determine the optimum number of transportation vessels to purchase and/or lease, inputs from a user are required. Inputs from a user include fixed cost to buy 1120, a lifespan of the vessel 1121, a variable cost to operate 1122, and cost to rent 1124.

A fixed cost to buy 1120 may refer to the cost to purchase the trailer itself, and may be set as either a total or as a cost per day of owning a vessel, excluding operating costs. The lifespan of the vessel 1121 may refer to the number of days that the vessel is expected to be in service. The variable cost to operate 1122 may refer to costs associated with maintaining the vessel, such as maintenance and other similar costs. The cost to rent per day 1124 may refer to the dollar amount that it costs to rent one trailer per day.

Once these inputs are provided, the vessel optimizer generates a recommended buy amount 1126 and a recommend rent amount 1128 based on the results provided by the optimization engine 218. Since the inputs provided by the user and the historical data inputs used to determine how many vessels are needed between node pairs is variable, the vessel optimizer utilizes a stochastic modeling approach.

Details 1130 are also presented for a user to view, which provides a breakdown of the recommended buy amount 1126 and recommended rent amount 1128. In the example shown, in order to reach a 98% optimization rate the number of transportation vessels needed would be between 800 and 5700 at any given time. Therefore, if the enterprise owns 5700 transportation vessels the enterprise system would be able to meet demand 98% of the time. If the enterprise system owns 4200 transportation vessels, the enterprise system would be able to meet demand 80% of the time. However, the exact number of transportation vessels to own and to rent is determined by the vessel optimizer based on the inputs provided by the user.

Details 1130 also show how many transportation vessels are needed between pairs of nodes 1114 and/or for a date range 1110. The data aggregates 1116 are used to determine how to distribute transportation vessels amount nodes within the enterprise system.

The vessel optimizer also determines how many transportation vessels the enterprise system should own and how many trailers on a price system should rent on a per-week, a per-month, or a per-year basis. The number of vessels needed in the enterprise system as shown may be tailored to a time frame as desired by the user.

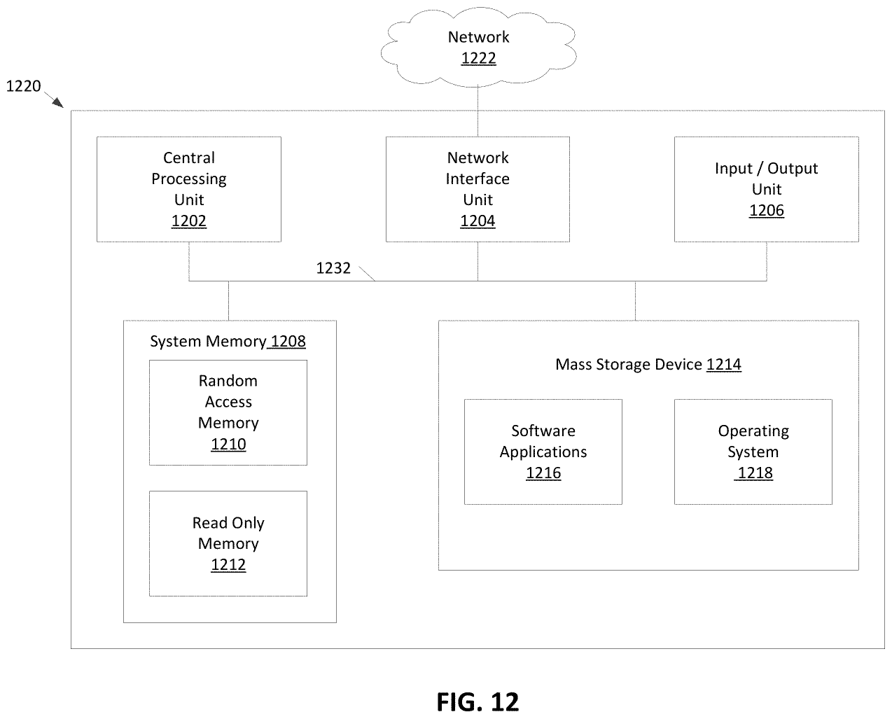

Referring now to FIG. 12, an example block diagram of a computing system 1220 is shown that is useable to implement aspects of the transportation vessel management system 202 of FIG. 2. In the embodiment shown, the computing system 1220 includes at least one central processing unit (“CPU”) 1202, a system memory 1208, and a system bus 1232 that couples the system memory 1208 to the CPU 1202. The system memory 1208 includes a random access memory (“RAM”) 1210 and a read-only memory (“ROM”) 1212. A basic input/output system that contains the basic routines that help to transfer information between elements within the computing system 1220, such as during startup, is stored in the ROM 1212. The computing system 1220 further includes a mass storage device 1214. The mass storage device 1214 is able to store software instructions and data.

The mass storage device 1214 is connected to the CPU 1202 through a mass storage controller (not shown) connected to the system bus 1232. The mass storage device 1214 and its associated computer-readable storage media provide non-volatile, non-transitory data storage for the computing system 1220. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 1202 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 1220.

According to various embodiments of the invention, the computing system 1220 may operate in a networked environment using logical connections to remote network devices through a network 1222, such as a wireless network, the Internet, or another type of network. The computing system 1220 may connect to the network 1222 through a network interface unit 1204 connected to the system bus 1232. It should be appreciated that the network interface unit 1204 may also be utilized to connect to other types of networks and remote computing systems. The computing system 1220 also includes an input/output controller 1206 for receiving and processing input from a number of other devices, including a touch user interface display screen, or another type of input device. Similarly, the input/output controller 1206 may provide output to a touch user interface display screen or other type of output device.

As mentioned briefly above, the mass storage device 1214 and the RAM 1210 of the computing system 1220 can store software instructions and data. The software instructions include an operating system 1218 suitable for controlling the operation of the computing system 1220. The mass storage device 1214 and/or the RAM 1210 also store software instructions, that when executed by the CPU 1202, cause the computing system 1220 to provide the functionality discussed in this document. For example, the mass storage device 1214 and/or the RAM 1210 can store software instructions that, when executed by the CPU 1202, cause the computing system 1220 to receive and analyze inventory and demand data.

In accordance with the present disclosure, and in particular with respect to the computing device disclosed in FIG. 12, it is noted that in some instances, rather than direct execution of software instructions on computing hardware, a virtualization system may be implemented that is configured to host and execute software instructions within a virtualized environment. In such instances, a portion of an enterprise-wide pool of computing systems may be allocated for execution of software instructions on an as-needed basis, e.g., for scaling to accommodate execution of simulations as discussed above for purposes of trailer fleet optimization. Additionally, such simulations may be performed concurrently on separately-allocated virtual machines to assist with parallelization of the process described above.

Referring to FIGS. 1-12 generally, it is noted that the systems and methods described herein have a number of advantages over existing approaches for transportation planning. In particular, the systems and methods described herein account for various types of variability—e.g., variability in demand and variability of price between different ownership models for transportation vessels, and apply appropriate weighted models for ensuring that transportation vessels are available and allocated to routes or node pairs within a large-scale supply chain network at a predetermined service level. At the same time, the systems and methods described herein avoid having to calculate an optimized vessel ownership solution for every possible historical data point, but rather apply random sampling to that data for purposes of executing simulations of overall transit time. This extracts worst-case scenarios from random distributions of different types of data sets (e.g., transit time data, dwell time data, backhaul transit times, etc.) that may be functionally independent or only loosely interdependent, and therefore allows users to plan for and allocate transportation vessels according to worst case scenarios. For example, a scenario of high transit time combined with high dwell time and high demand may not have actually occurred in connection with one another in the past, but statistically might be likely to occur in the future. Such a scenario would be automatically captured and accommodated by the modeling, scenario execution, and optimization processes discussed herein.

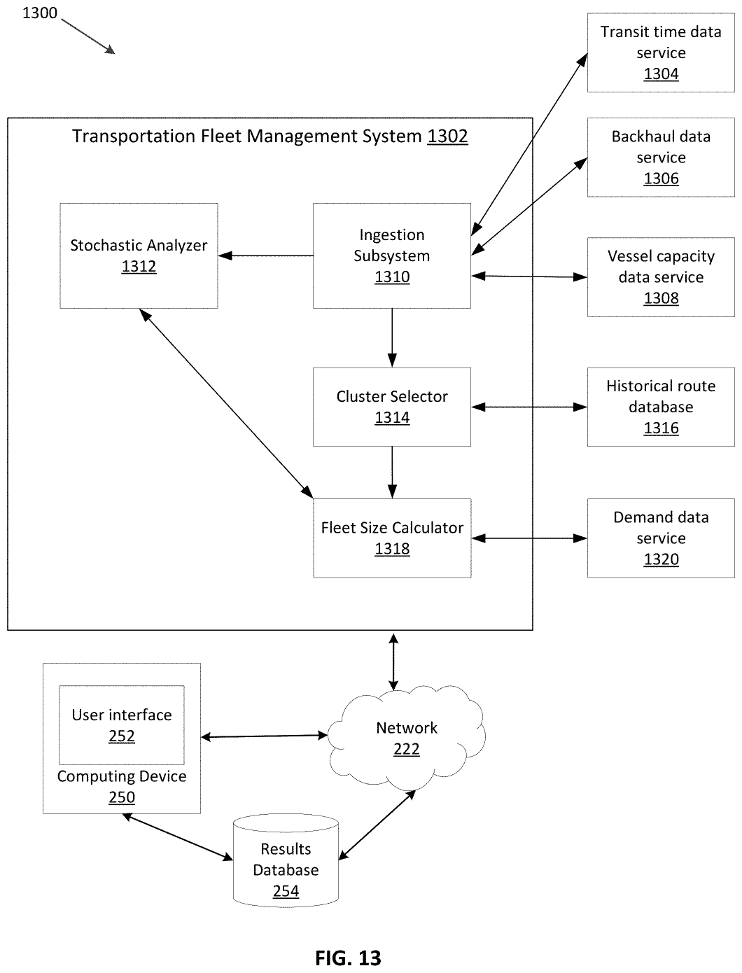

Referring to FIGS. 13-20, below, another approach for modeling the number of transportation vessels needed is described below. In such an alternative method, a plurality of locations are identified based at least in part on a historical route frequency among the plurality of locations. A cluster includes at least one distribution location and a plurality of receiving locations. Optimized routes are dynamically selected for each of the identified clusters. The optimized routes are selected based at least on the demand for each location, inputs such as historical transit times between a plurality of locations, historical backhaul routes and capacity, as well as the plurality of historical routes. The number of transportation vessels needed is identified based on the dynamically selected optimized routes.

Accordingly, while the methodology described above in connection with FIGS. 1-12 may be applicable in point-to-point transportation systems (e.g., where routes typically occur between two nodes of a supply chain), the methodology described below may be used in particular instances where routes may involve multiple points, e.g., multiple drop-off locations for which optimization of routing and number of vessels may be determined. Such an arrangement may be useable in a situation where a transportation vessel is set to deliver many similar goods to the various locations, e.g., in the case of grocery or other refrigerated goods. However, the disclosure presented herein may be applied in any multi-point delivery context.

FIG. 13 illustrates a schematic diagram of an example system 1300 for implementing a transportation fleet management system 1302. The transportation fleet management system 1302 can be implemented in the form of a software tool executable on a computing device, such as the device seen in FIG. 12. Components of the transportation fleet management system 1302 include an ingestion subsystem 1310, stochastic analyzer 1312, a cluster selector 1314, and a fleet sizing calculator 1318.

Each input received is based on a single location, or a plurality of locations. Each output is based on a plurality of locations in an enterprise-wide system, including at least one distribution location and a plurality of receiving locations.

The ingestion subsystem receives inputs from a plurality of databases and/or data services, such as data services 1304, 1306, 1308. The transit time historical inputs are received by a transit time data service 1304, which is accessed via a transit time API after receiving a request from the ingestion subsystem 1310. A backhaul data service 1306 may be accessed to obtain historical backhaul transit times that may be incorporated in an overall route plan. The vessel capacity historical inputs are received from the vessel capacity data service 1308, which is called by a vessel capacity API from the ingestion subsystem 1310.

Transit time historical inputs may refer to the time that it takes a transportation vessel to travel between any two locations, as well as (optionally) total time in transit while traveling an entire route including more than two locations. This can include, for example backhaul time that may typically be associated with a particular route. Accordingly, in example embodiments, the transit time data service 1304 and backhaul data service 1306 may be combined. In an example, the transit time may be measured in minutes, hours, days, or weeks.

Dwell time historical inputs are defined as the time that a transportation vessel is not in transit. For example, dwell time includes the unload time at a destination location as well as the load time at origination location. Further, dwell time may include time that the transportation vessel is undergoing maintenance work, or is not being used (underutilization). Dwell time may also be measured in minutes, hours, days, or weeks. Although dwell time may not generally be considered during use of all models (e.g., because such dwell time is incorporated into the transit time between a next two segments within a multi-segment route, or for any of a variety of other reasons), in some cases, dwell time may be considered for purposes of route planning, vessel arrival planning at each location, etc. In such instances, dwell time may be obtained from a further remove data service (not shown).

Vessel capacity historical inputs are defined as the size of the transportation vessel used in previous routes and how full the transportation vessel was. The vessel capacity historical inputs can also include information related to trailer cube utilization, which is defined as how full an individual cube or transportation vessel is and/or how many cubes are on a single transportation vessel.

In response to receiving the inputs, the ingestion subsystem 1310 provides the data to cluster selector 1314 and stochastic analyzer 1312.

The stochastic analyzer 1312 uses the historical inputs to predict future transit times, dwell times, and vessel capacity. In some embodiments, the stochastic analyzer 1312 predicts transit times, backhaul and vessel capacity based on a randomly selected value selected from within a range of values defined by the historical inputs, with the randomly selected values being weighted toward those values more frequently encountered among the historical inputs. The stochastic analyzer 1312 passes predictive inputs to the fleet size calculator 1318.

The cluster selector 1314 receives historical route frequency information from a historical route database 1316. The cluster selector 1314 uses the historical routes to determine an appropriate grouping of locations, which is referred to herein as a cluster. The historical route frequency information includes the number of times specific locations occur in the same route over the past year.

The cluster selector 1314 selects the best route for the identified cluster based at least in part on the historical routes, and passes the selected and optionally all historical routes for each identified cluster to the fleet size calculator 1318.

In the embodiment shown, the fleet size calculator 1318 receives information from the cluster selector 1314 and the demand data service 1320. In example embodiments, the demand data service 1320 is a database that relays the inventory demands for each individual location to the route optimizer 1318. If not already selected, the fleet size calculator 1318 selects the best route for the identified cluster based at least in part on the historical routes received from the cluster selector 1314 and the demand received from the demand data service 1320.

The fleet size calculator 1318 also uses data received from the cluster selector 1314 and the stochastic analyzer 1312 to determine an optimum fleet size for an enterprise system, based on a predetermined service level. For example, the fleet size optimizer 1318 can determine, based on identified routes, demand, and transit time, optimal routes to maximize utilization of each vessel, while ensuring sufficient and vessels are allocated to meet the predetermined service level, given that the various possibilities driven by the stochastic predictions on which that optimization is based.

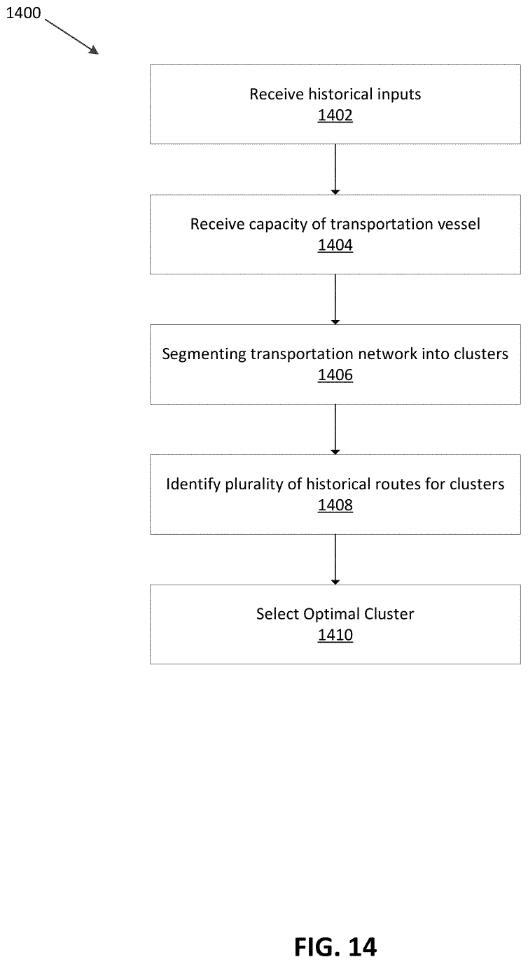

FIG. 14 illustrates an example method 1400 for selecting optimized clusters based at least on historical routes, predicted demand, and transportation vessel capacity.

At step 1402, historical inputs are received. Historical inputs include, at least, historical transit times among a plurality of locations, and historical demand at the plurality of locations. Other historical inputs taken into consideration can include: when locations take deliveries, an individual location's delivery schedule, and starting time for deliveries. Although not considered in all circumstances, in some examples of the method 1200, additional considerations may include cost per mile of transit, penalty for delayed deliveries, penalty for missed deliveries, and the cost of holding transportation vessels at a distribution center.

At step 1404, the capacity of at least one predetermined transportation vessel type is received. For example, a trailer is the transportation vessel type and has lengths selected from 28 feet or 53 feet. Additionally, or alternatively, the size of cubes or how many cubes fit in transportation vessel is received.

At step 1406, the transportation network is segmented into clusters. Each cluster contains at least one distribution location and a plurality of receiving locations, such as a retail store. The clusters are identified based at least in part on historical route frequency among the plurality of locations. Clusters are described in more detail at FIG. 14.

At step 1408, a plurality of historical routes for each cluster identified is determined. In this example, it may be noted that a cluster of locations (e.g., stores) are commonly grouped for purposes of delivery via a single transportation route; however, for that cluster, the specific routes among those locations are not defined. Rather, for each cluster identified in step 1406, all the historical routes used in the past year are identified. In some embodiments, the frequency of use of a particular route may be tallied, as well as the details for each route, such as the time it takes to complete the route, the total miles of the route, and other similar details. In this way, an optimal route and/or optimal packing of a vessel may be determined.

At step 1410, an optimized cluster is identified. The optimized cluster is dynamically selected and is based at least in part on the daily demand for each location within the cluster and the frequency of historical routes among the locations in the cluster. The optimized cluster is one in which a predetermined service level is met. For example, one objective in meeting a predetermined service level is to ensure sufficient vessels are available given a forecast demand, while also maximizing utilization of each transportation vessel.

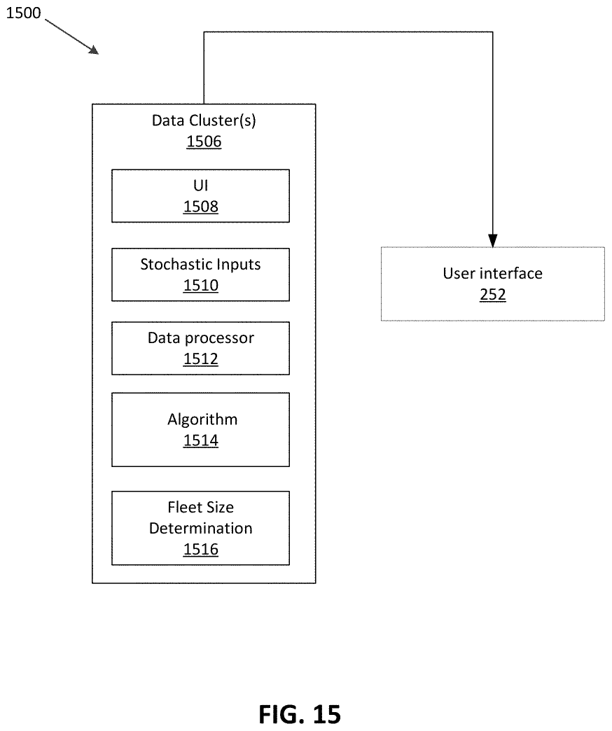

FIG. 15 illustrates an example block diagram 1500 for data collection. The data collected includes data for every route, and the details of each location stop.

The diagram 1500 illustrates an example process for data preparation for determining an optimum fleet size for an enterprise system. The process includes the following general steps: (1) raw data is stored in data clusters (shown as clusters 1506 generally), (2) manual inputs are received from a user and are inputted into the clusters 1506, (3) models are run using the manual inputs as well as stochastic inputs, and (4) outputs are provided to the user interface 252. The output will include adjustable parameters such as demand, acceptable idle transportation fleet size, to gauge the impact on overall recommended enterprise fleet size.

In the example shown, the database clusters 1506 can be hosted or accessed by an application platform, and receive data from the database management system 1504 for further processing. Database cluster 1506 can include UI 1308, stochastic inputs 1510, data processor 1512, network selection algorithm 1514, and fleet size determination 1516. Based on the stochastic inputs 1510 obtained from stored historical data, test models are run.

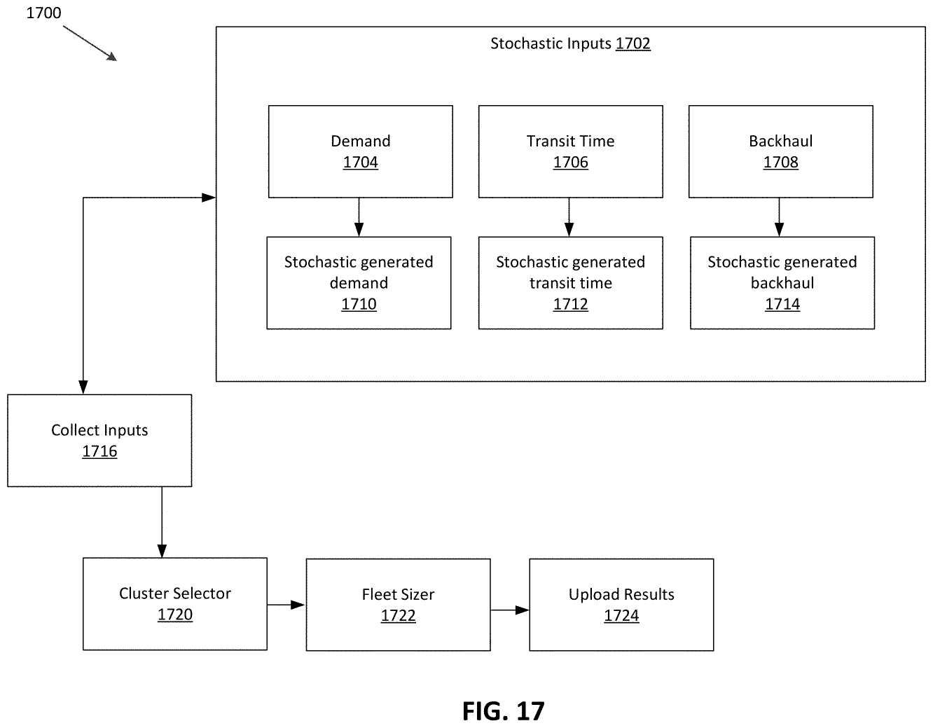

In the example shown, the user interface 252 allows a user to view, for example modeling tools that define clusters and routes that are identified via the docker container 1506. The stochastic inputs 1510 represent, for example demand, transit time, and backhaul times generated from historical data, location delivery window, transportation cost, and network configuration, as described below in connection with FIG. 17.

The data processor 1512 normalizes received data for use by the network selection algorithm 1514. This can include, for example, normalizing dates and times received from various reporting systems that provide, e.g., the lead time, historical routing, demand, and/or other stochastic inputs.

The network selection algorithm 1514 generally receives the historical inputs and additional information (e.g., capacity of transportation vessels) to perform the method 1400 seen in FIG. 14, above. Specifically, the network selection algorithm 1514 receives the segmentation of the transportation network into clusters, including the plurality of historical routes for the clusters, and the cluster and routing information based on that historical information. The network selection algorithm 1514 also receives the forecast demand, and uses the historical information to predict the number of transportation vessels needed for a specific day, the number of transportation vessels that return on a given day, and the optimal capacity of each transportation vessel.

Once the number of clusters and routes are selected, a fleet sizer determination 1516 is performed. Generally, the fleet sizer determination 1516 obtains the routes and cluster information to identify the number of transportation vessels required to meet the predetermined service level given a forecast demand at each location.

Referring to FIG. 15 generally, it is noted that utilizing the cluster and distributed database arrangement described herein, simulations used for appropriate fleet sizing may be performed in-place within the database, improving execution efficiency.

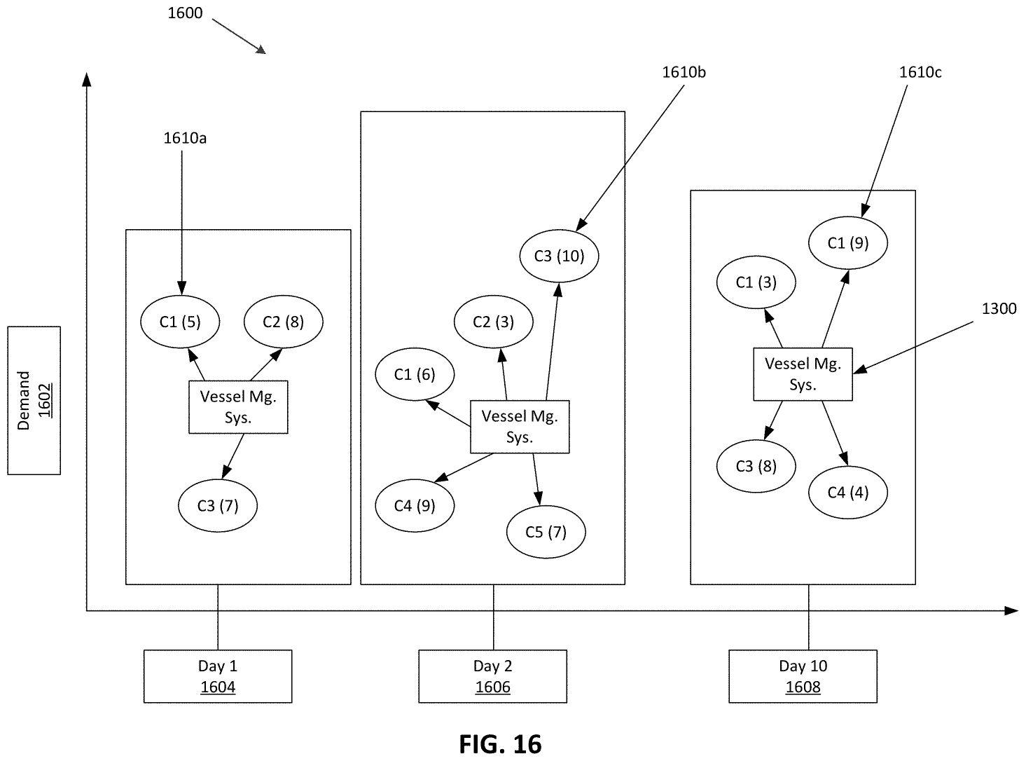

FIG. 16 illustrates an example diagram 1600 showing clustering of locations based on demand 1602, on a per-day basis. Depending on demand 1602 at each location, different clusters 1610a, 1610b, 1610c may exist on different days 1604, 1606, 1608.

As shown, day one 1604 includes three clusters 1610. Each cluster 1610 includes a different number of locations. The first cluster 1610a (denoted as C1 on day one) includes five locations (shown in parenthesis in the figure), the second cluster (C2) includes eight locations, and the third cluster (C3) includes seven locations. Day two 1606 includes five clusters 1610 and day ten 1608 includes four clusters 1610.

The transportation fleet management system 1302 clusters the locations each day to meet a predetermined service level. As shown, there are a different number of clusters 1610 each day, and each cluster 1610 has a different number of locations (e.g., stores). A location (e.g., a store) in the first cluster 1610a on day one 1604 may be in a different cluster 1610b on day two 1606. A single location is only in one cluster each day. The cluster are selected to meet a predetermined service level e.g., to ensure that a predetermined transportation capacity is met at least a predetermined amount of time based on anticipated demand among a plurality of locations in a supply chain network.

The transportation fleet management system 1302 can also determine, for each cluster 1610, the minimum and/or maximum size transportation vessel(s) needed for each cluster. Further, the transportation fleet management system 1302 can predict the minimum and/or maximize size transportation vessels for each cluster for each day in the future, and determine an enterprise-wide fleet size to meet the predetermined service level.

FIG. 17 illustrates an example flowchart 1700 for predicting an optimum enterprise-wide transportation fleet size.

The flowchart 1700 includes stochastic inputs 1702 including historical inputs including demand 1704, transit time 1706, and backhaul 1708. The historical inputs are used to predict the stochastic generated input. The historic demand 1704 is used to determine the stochastic generated demand 1710, the transit time 1704 is used to determine the stochastic generated transit time 1710, and the historic backhaul 1704 is used to determine the stochastic generated backhaul 1710.

The stochastic inputs 1702 are collected 1716 and passed to cluster selector 1720. Cluster selector 1720 determines which locations are to be clustered together for a particular route (e.g., on a daily and/or weekly basis). The fleet sizer 1722 determines the number of transportation vessels needed each day based on the stochastic inputs 1702 and the cluster identified. The fleet sizer 1722 passes this information to the upload results 1724, which allows a user to view the details on a user interface. The user may view how many transportation vessels are needed each day, and which locations are being serviced by an individual transportation vessel, as well as the predicted number of transportation vessels needed enterprise-wide for the next year. A user may use this information to ensure the enterprise has enough transportation vessels to meet the needs of the enterprise in the coming year, as well as the appropriate locations and routes for each vessel on a daily/weekly basis.

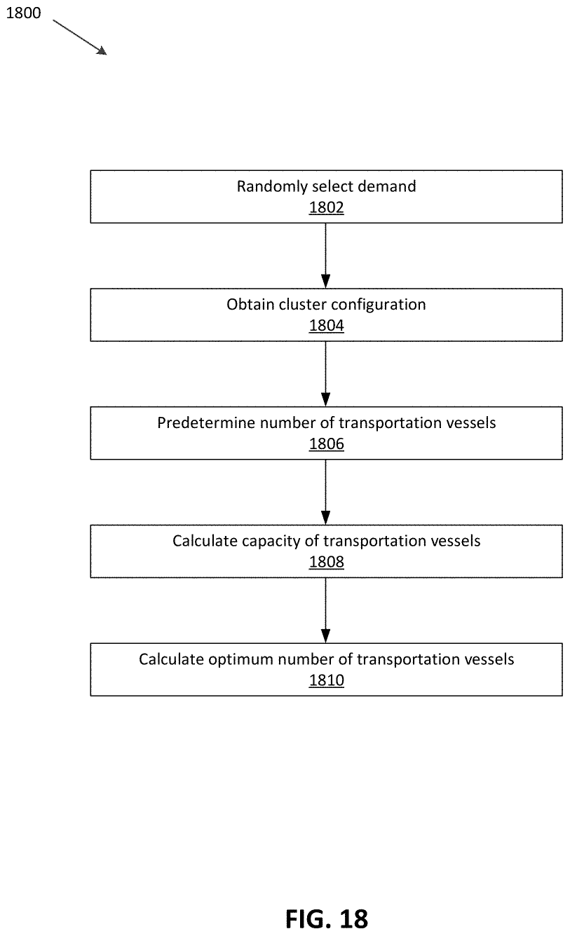

FIG. 18 illustrates a flowchart 1800 including steps for performing a simulation driven by stochastic parameters including network size determined by cluster count to determine an optimum transportation fleet size for an enterprise system. The simulation includes a variety of parameters including, but not limited to, demand, cluster configuration, transit time, backhaul, and trailer cube utilization. In an example, the simulation is run for seven days; however, in other illustrations, other simulation times may be used.

The simulation may also be run when a new location is added to the enterprise system. In an example, when a new location is added, the simulation determines which cluster the location should be added to.

At step 1802, demand is randomly determined for each day of the seven day simulation. Demand may be generated based at least in part by historical demand for each location in a plurality of locations.

At step 1804, a cluster configuration is selected. The locations are clustered based at least in part on the demand of the individual locations, as well as historical clustering of locations. Historical clustering of locations includes which locations were on the same route in previous deliveries.

In example embodiments, a k-means clustering (or some variant thereof) is performed to group locations according to, e.g., common attributes; however, alternative clustering methodologies may be utilized as well. In example embodiments, a “k-modes” clustering process is performed that groups matching categorical data points based on attributes. In such an embodiment between 23-30 groups or clusters are formed, with attributes used corresponding to, among other features, square feet, store format, class, market, and distribution region (thereby typically grouping locations having a common distribution center together for purposes of route and vessel selections). From this, historical shipment data may be aggregated for the clustered locations, and a histogram formed based on the cluster and historical demand, and a best-fit distribution for stores in a particular cluster are determined (separately for each cluster). Store demand may be generated by sampling from this distribution.

At step 1806, the number of transportation vessels is selected. At least one transportation vessel per cluster is required (since each cluster will generally be associated with a determined set of routes to be associated with a particular transportation vessel). The selected number of transportation vessels is selected to satisfy the needs for a predetermined time period (e.g., seven days) of the simulation.

At step 1808, the capacity of the transportation vessels is calculated. The capacity is determined based at least in part on the demand predicted in step 1802, as well as the number of transportation vessels identified in step 1806. Capacity may also be determined based on historical demand for each of the locations, or using equation (2) described below.

Equation (2) assumes that the number of transportation vessels existing at the beginning of a day equals the total capacity existing at the beginning of the day, in other words, each transportation vessel is fully loaded. Equation (2) takes into consideration the number of transportation vessels at the beginning of day ‘t−1’ for a specified demand ‘i’ (SOᵢₜ₋₁), the number of transportation vessels sent at the beginning of the day ‘t−1’ for demand ‘i’ (Lᵢₜ₋₁), and the number of transportation vessels returned by the beginning of the day ‘t−1’ for demand ‘i’ and network configuration ‘j’ (Mᵢₜ₋₁).

SOᵢₜ=SOᵢₜ₋₁−Lᵢₜ₋₁+Mᵢₜ₋₁ Eq. (2)

Accordingly, the result of Equation 2, above (i.e., SOᵢₜ) corresponds to a number of trailers at the beginning of the day “t”, in situations where the transportation vessels associated with a cluster may be in use for more than one day at a time (e.g., used for a multi-day route).

At step 1810, the optimum number of transportation vessels is calculated. The optimum number of transportation vessels is selected based at least in part of the capacity of the transportation vessels determined at step 1808, as well as meeting a predetermined service level. For example, if the capacity of the transportation vessels is low, then the optimum number of transportation vessels may be less than determined at step 1806, because the transportation vessels may have a fuller capacity in an optimal situation.

Another method of determining the optimum number of transportation vessels includes determining the optimal capacity of the transportation vessels. The optimal capacity is determined by using equations (3)-(6). These equations use trailers as an example of a transportation vessel. Equations (3), (4), and (5) represents the trailers that return on day ‘t−1’ based on the summation of trailers that left on day ‘t−α’. Equations (3), (4), and (5) take into consideration network configuration ‘j’ (Mᵢₜ), the number of trailers sent at the beginning of the day ‘t−1’ for demand ‘i’ (Lᵢₜ₋₁), total transit time corresponding to cluster Cᵢₖₜ to be obtained from the distribution ‘k’ obtained from the network selection algorithm (ttᵢₖₜ), the number of trailers at the beginning of day ‘t−1’ for a specified demand ‘i’ (SOᵢₜ₋₁).

$$\begin{matrix} {M}_{it} = {\sum }_{day = 2}^{7} \sum \text{?} \text{?} {L}_{( day - t ) α} . & Eq . ( 3 ) \\ dlvr\_days = \{ \begin{matrix}1 , when {tt}_{ikt} \leq 12 hrs \\ 2 , when {tt}_{ikt} > 12 hrs and \leq 36 hrs \\ 3 , when {tt}_{ikt} 36 - 60 hrs\end{matrix} & Eq . ( 4 ) \\ For t = 2 to 7 \text{:} \\ If {So}_{it} = - λ where λ > 0 then {So}_{i 0} = {So}_{i 0} + λ \\ \text{?} \text{indicates text missing or illegible when filed} & Eq . ( 5 )\end{matrix}$$

Equation (6) takes into consideration the number of trailers at the beginning of day ‘t’ for a specified demand ‘i’ (SOᵢₜ), the number of trailers sent at the beginning of the day T for demand ‘i’ (Lᵢₜ), and remaining unutilized trailers (uᵢₜ).

SO_{iO}−Lᵢₜ=μᵢₜ Eq. (6)

In equation 6, above, SOᵢ₀ is set to SOᵢ₀−min(μᵢₜ), where SOᵢ₀ corresponds to an optimal capacity for a week, for a particular demand ‘i’.

Accordingly, the method of flowchart 1800 may be used to predict the cluster configuration and a corresponding number of transportation vessels needed in either an existing enterprise transportation network configuration, and additionally can be used if a location is added to the enterprise transportation network.

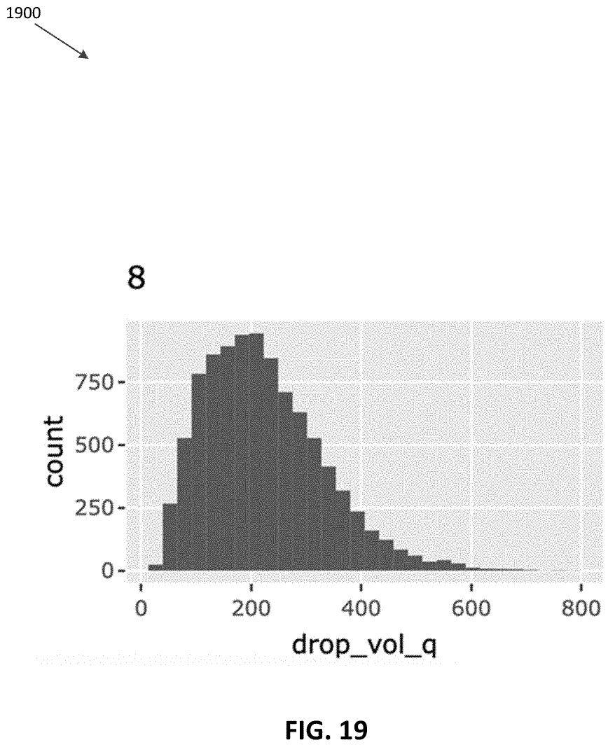

Referring now to FIG. 19, an example graph 1900 is shown that displays a histogram of shipment volumes for delivery locations within a particular cluster. In the example shown, a frequency at which each shipment volume is experienced within a given cluster is illustrated, allowing for planning of numbers of transportation vessels assigned to that cluster and routes within the cluster. In particular, a particular service level may be selected for the cluster given the historical shipment volumes and anticipated demand as described above in conjunction with FIG. 18. In particular, such historical shipment information can be used, once aggregated in a histogram on a per-cluster basis, to generate an anticipated demand curve that can be sampled to determine a forecast demand for a particular cluster or location. Accordingly, each cluster (and accordingly, each location) can be separately assessed to determine anticipated demand and historical shipment volume distributions.

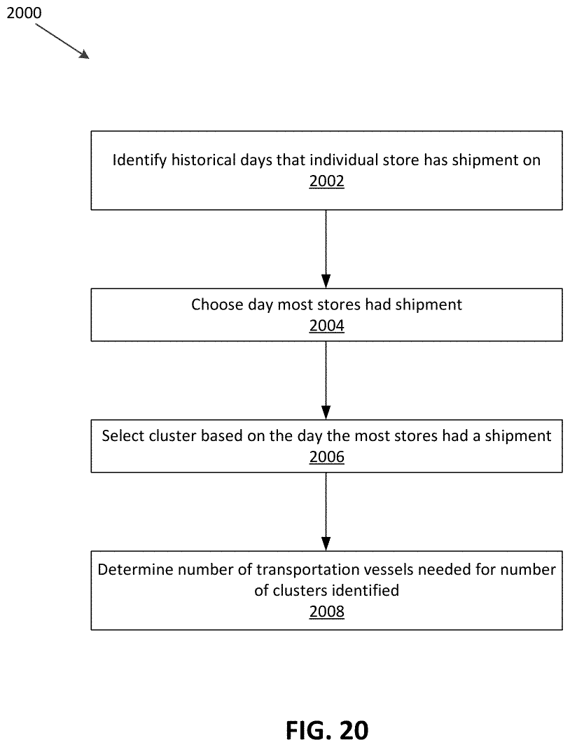

FIG. 20 illustrates an alternative example method 2000 including steps to determine the number of transportation vessels needed.

At step 2002, the historical days that an individual location receives shipments are identified. Each time an individual location receives a shipment, the details of the shipment are recorded. A particular location may receive a shipment every day, or may receive a shipment once per week. Details include the size of the shipment, what time the shipment was received by the location, how long the transportation vessel was at the location, and the capacity of the individual trailer cube.

Still further, the details of the shipment may include when the location accepts shipments, how often a location rejects a shipment, and other similar details.

At step 2004, the day that the most locations received a shipment is selected by the transportation fleet management system. This represents the maximum number of transportation vessels that may be needed on a given day.

At step 2006, clusters are selected based on the day selected in step 1904. Clusters are selected to maximize the capacity of the transportation vessels. The historical shipments details are used to anticipate the capacity needed for each transportation vessel.

At step 2008, the number of transportation vessels needed for the clusters identified is determined. The number of transportation vessels needed includes utilizing at least one size of transportation vessels. In an embodiment where the enterprise includes more than one size of transportation vessel, the method 2000 is re-run for each size of transportation vessel.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

Referring to FIGS. 13-20 generally, it is noted that the systems and methods described herein have a number of advantages over existing approaches for transportation planning. The transportation fleet management system provides a method to accurately predict the number of transportation vessels needed to deliver inventory to a plurality of locations, while ensuring capacity exists to a predetermined service level and optimizing both the number of transportation vessels and how the transportation vessels are distributed among a set of route, given the fixed transportation vessel capacity and the anticipated demand. The transportation fleet management system is also capable of predicting the transportation vessel needs when a new location is added to the network, instead of adding an additional transportation vessel to service the added location.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method of managing transportation vessels within an enterprise system, the method comprising:
receiving, at a software tool implemented on a computing system, inputs related to historical transportation vessel usage, the inputs including historical transit times between a plurality of locations, and capacity of at least one predetermined transportation vessel type;
automatically segmenting a transportation network into a plurality of clusters of locations, each of the clusters of locations being identified based at least in part on a historical route frequency among a plurality of locations and including at least one distribution location and a plurality of receiving locations;
for each cluster of the plurality of clusters, identifying each of a plurality of historical routes among the plurality of locations that are included in the cluster; and
dynamically selecting optimized routes for a plurality of transportation vessels across the plurality of clusters based at least in part on demand for each location within the transportation network, the inputs, and the plurality of historical routes.

2. The method of claim 1, wherein the historical transit times between the plurality of locations includes a backhaul time between a last receiving location of the plurality of receiving locations and the at least one distribution location.

3. The method of claim 1, wherein the optimized route is further based on a predetermined service level.

4. The method of claim 1, wherein the predetermined service level is at least 98%.

5. The method of claim 1, wherein automatically segmenting a transportation network into a plurality of clusters of locations further includes:
receiving a new location;
identifying at least one cluster, the at least one cluster capable of including the new location;
generating a new route including the new location; and
generating a set of outputs including the new route, an estimated minimum route length and an estimated maximum route length.

6. The method of claim 1, wherein automatically segmenting a transportation network into a plurality of clusters of locations further includes:
identifying all location combinations that have occurred in the past year and identifying historical clusters;
identifying routes taken for each historical cluster and generating historical routes;
generating a set of outputs including a historical route frequency, a minimum historical route length, and a maximum route length.

7. The method of claim 1, wherein the demand comprises a daily demand.

8. The method of claim 1, wherein dynamically selected optimized routes are further based on constraints selected from location demand, and network configuration.

9. The method of claim 1, wherein a number of transportation vessels to meet the predetermined service level is automatically determined based on the dynamically selected optimized routes.

10. The method of claim 9, wherein determining the number of transportation vessels is based at least in part on determining the optimal capacity of the transportation vessels.

11. A system for managing transportation vessels within an enterprise system, the system comprising:
a computing system including a data store, a processor, and a memory communicatively coupled to the processor, the memory storing instructions executable by the processor to:
receive inputs related to historical transportation vessel usage, the inputs including historical transit times between a plurality of locations and capacity of at least one predetermined transportation vessel type;
automatically segment a transportation network into a plurality of clusters of locations, each of the clusters of locations being identified based at least in part on a historical route frequency among a plurality of locations and including at least one distribution location and a plurality of receiving locations;
for each cluster of the plurality of clusters, identify each of a plurality of historical routes among the plurality of locations that are included in the cluster; and
dynamic select optimized routes for a plurality of transportation vessels across the plurality of clusters based at least in part on demand for each location within the transportation network, the inputs, and the plurality of historical routes.

12. The system of claim 11, wherein the optimized routes are further based on stochastic inputs that are received from a stochastic database, the stochastic inputs based at least in part on the historical transportation vessel usage, historical transit times, and backhaul times.

13. The system of claim 11, wherein automatically segmenting a transportation network into a plurality of clusters of locations further includes:
receiving a new location;
identifying at least one cluster, the at least one cluster capable of including the new location;
generating a new route including the new location; and
generating a set of outputs including the new route, an estimated minimum route length and an estimate maximum route length.

14. The system of claim 11, wherein automatically segmenting a transportation network into a plurality of clusters of locations further includes:
identifying all location combinations that have occurred in the past year and identifying historical clusters;
identifying routes taken for each historical cluster and generating historical routes;
generating a set of outputs including a historical route frequency, a minimum historical route length, and a maximum route length.

15. The system of claim 11, further comprising generating via the computing system, a user interface providing a selectable view of the optimized number of transportation vessels required to meet a predetermined service level based on the dynamically selected optimized routes.

16. The system of claim 11, further comprising generating via the computing system, a user interface providing a selectable view of the clusters of locations and the selected optimized route.

17. The system of claim 11, further comprising receiving a set of constraints selected from among location demand, location delivery window, transportation cost, and network configuration, and wherein the dynamically selected optimized routes is further based on the constraints.

18. A non-transitory computer-readable medium comprising computer-executable instructions which, which executed by a computing system cause the computing system to perform a method of managing inventory items in a supply chain, the method comprising:
receiving, at a software tool implemented on a computing system, inputs related to historical transportation vessel usage, the inputs including historical transit times between a plurality of locations and capacity of at least one predetermined transportation vessel type;
automatically segmenting a transportation network into a plurality of clusters of locations, each of the clusters of locations being identified based at least in part on a historical route frequency among a plurality of locations and including at least one distribution location and a plurality of receiving locations;
for each cluster of the plurality of clusters, identifying each of a plurality of historical routes among the plurality of locations that are included in the cluster; and
dynamically selecting optimized routes for a plurality of transportation vessels across the plurality of clusters based at least in part on demand for each location within the transportation network, inputs, and the plurality of historical routes.

19. The method of claim 18, wherein automatically segmenting a transportation network into a plurality of clusters of locations further includes:
receiving a new location;
identifying at least one cluster, the at least one cluster capable of including the new location;
generating a new route including the new location; and
generating a set of outputs including the new route, an estimated minimum route length and an estimate maximum route length.

20. The method of claim 18, wherein the optimized routes are further based on stochastic inputs received from a stochastic database, the stochastic inputs being selected based at least in part on the historical transportation vessel usage, historical transit times, and backhaul times.

21. The method of claim 18, wherein a number of transportation vessels to meet the predetermined service level is identified based on the dynamically selected optimized routes.
